(19) United States
(12) Patent Application Publication
(10) Pub. No.: US 2023/0169883 A1
(43) Pub. Date: Jun. 1, 2023

(54) METHOD FOR DETECTING AND AFFIRMING INTENT TO CONSUME A SUPPLEMENT

(71) Applicant: Serotonin, Inc., San Francisco, CA (US)

(72) Inventors: Rajesh T.S. Reddy, San Francisco, CA (US); Shobini Appanderanda, San Francisco, CA (US); Srinivasan S, Puducherry (IN); Poornima Malepati, Andhra Pradesh (IN); Matt Leanse, San Francisco, CA (US)

(21) Appl. No.: 18/073,495

(22) Filed: Dec. 1, 2022

Related U.S. Application Data
(60) Provisional application No. 63/285,016, filed on Dec. 1, 2021.

(51) Int. Cl. G09B 19/00; G06K 7/10

(52) U.S. Cl. CPC G09B 19/0092; G06K 7/10366; G08B 6/00

(57) ABSTRACT

A method for detecting and affirming intent to consume a supplement includes: at a wearable device worn on a hand of a user, broadcasting a wireless interrogation signal; and receiving an inbound wireless identifier responsive to the wireless interrogation signal. The method also includes, in response to the inbound wireless identifier matching a tag identifier linked to a supplement in a user profile associated with the user: detecting proximity of the supplement to the user; predicting intent of the user to consume a dose of the supplement; retrieving a consumption window for the supplement from a supplement regimen in the user account; and. in response to the current time falling outside of the consumption window, vibrating the wearable device according to a second vibration pattern during a haptic consumption avoidance cycle to prompt the user to delay consumption of the supplement.

### CROSS-REFERENCE TO RELATED APPLICATIONS

This application claims the benefit of U.S. Provisional Application No. 63/285,016, filed on 1 Dec. 2021, which is incorporated in its entirety by this reference.

### TECHNICAL FIELD

This invention relates generally to the field of health and wellness and more specifically to a new and useful method for detecting and affirming intent to consume a supplement in the field of health and wellness.

### BRIEF DESCRIPTION OF THE FIGURES

FIG. 1 is a flowchart representation of a method.

FIG. 2 is a graphical representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

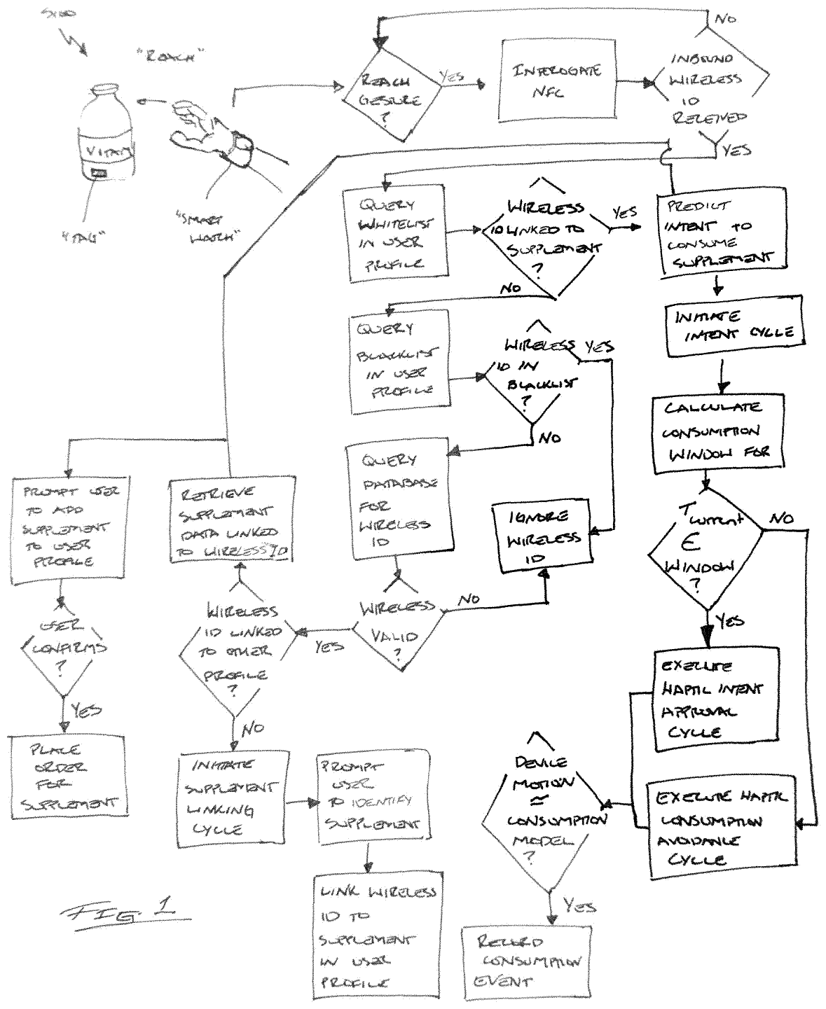

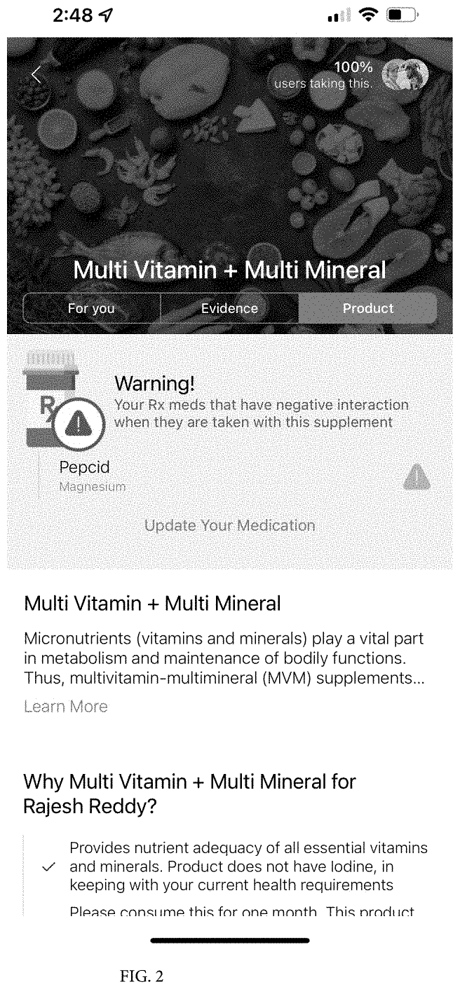

As shown in FIG. 1, a method S100 for detecting and affirming intent to consume a supplement includes: at a wearable device worn on a hand of a user, broadcasting a wireless interrogation signal; and receiving an inbound wireless identifier responsive to the wireless interrogation signal. The method S100 also includes, in response to the inbound wireless identifier matching a tag identifier linked to a supplement in a user profile associated with the user: detecting proximity of the supplement to the user; predicting intent of the user to consume a dose of the supplement; and retrieving a consumption window for the supplement from a supplement regimen in the user account. The method S100 further includes, in response to a current time falling within the consumption window, vibrating the wearable device according to a first vibration pattern during a haptic intent approval cycle to confirm consumption of the supplement while the wearable device is proximal the supplement. The method S100 also includes, in response to the current time falling outside of the consumption window, vibrating the wearable device according to a second vibration pattern during a haptic consumption avoidance cycle to prompt the user to delay consumption of the supplement (or not consume the supplement at the current time, as shown in FIG. 2).

### 2. Applications

Generally, the method S100 can be executed by an application (e.g., a native application) executing on a wearable device (e.g., a smartwatch) worn by a user to: broadcast queries for wireless identifiers, such as responsive to detecting a “reach” gesture at the wearable device or a specific gesture trained for the system (e.g., a “reach and shake” gesture); ingest inbound wireless identifiers responsive to the query, such as from NFC or other short-rage passive or active wireless transmitters near the wearable device; and compare these inbound wireless identifiers to stored identifiers of tags installed on packages containing supplements specified in a supplement regimen defined in the user's profile.

If the application successfully matches an inbound wireless identity to a tag identifier linked to a particular supplement specified in the supplement regimen, the application can: confirm that the current time falls within a scheduled time window for consuming the particular supplement; confirm that sufficient time has passed since the user last consumed a dose of the particular supplement; and/or confirm that sufficient time has passed—since the user consumed each other supplement specified in the supplement regimen—sufficient to avoid negative drug interactions between the particular supplement and these other supplements recently consumed by the user. If the application successfully clears these checks, the application can trigger the wearable device to output haptic (and/or visual) feedback—such as in the form of a soft, slow “rumble”—to indicate that the application has completed these checks and approved consumption of the particular supplement at the current time.

Conversely, if the application fails at least one of these checks, the application can trigger the wearable device to output haptic (and/or visual) feedback—such as in the form of a rapid, high amplitude sequence of pulses—to indicate that these checks failed and that consumption of the particular supplement is not recommended at the current time.

Therefore, the application can execute Blocks of the method S100 to: predict intent of a user to consume a supplement based on inbound wireless identifiers received from passive tags located on these supplements; check feasibility of consuming the supplement at the current time by the user; and then selectively return haptic feedback to the user to confirm consumption of the supplement or recommend against consumption of the supplement. More specifically, rather than transmit reminders to consume certain supplements to the user over time, the application can selectively confirm or deny consumption of a supplement when the application detects proximity of the supplement to the wearable device (e.g., when the supplement is in the user's hand; immediately after the user grasps the supplement), thereby providing real-time, immediately-actionable supplement guidance to the user when the user is most in need of and most sensitive to this guidance.

### 3. System

Generally, the method S100 is described herein as executed by a system that includes: a population of NFC tags (or “stickers”) configured for application onto supplement packages and to broadcast unique wireless identifiers when interrogated with an NFC reader; an application (e.g., a native application) executing on a wearable device (e.g., a smartwatch) worn by a user; and a remote database or computer system configured to store unique identifiers of these tags and links between users, supplements, supplement data (e.g., manufacturer, batch codes, expiration dates, etc.), and these unique identifiers.

Furthermore, the method S100 is described herein as executed by the system to predict and respond to a user's intent to consume supplements. Additionally or alternatively, the system can execute the method S100 to predict and respond to a user's intent to consume medications, drugs, food, etc.

Furthermore, the method is described herein as executed by or in conjunction with a wearable device to detect and respond to a user's intent to consume a supplement based on proximity of the wearable device to a tag and motion of the wearable device. However, Blocks of the method can additionally or alternatively be executed by smartphone or desktop, countertop, or other mobile or static device to detect and respond to a user's intent to consume a supplement responsive to the user tapping a supplement package against the mobile or static device.

### 4. Tag Detection and Initial Handling

The application can interface with a short-range wireless reader (e.g., including an interrogator and an antenna) within the wearable device to interrogate and read wireless identifiers from these tags. In particular, throughout operation, the application triggers the NFC reader in the mobile device to broadcast a wireless query and to record wireless identifiers broadcast by nearby NFC transmitters, such as in tags applied to supplement containers.

In one implementation, the application (or the user's smartphone or a remote database) stores a whitelist of tag identifiers previously linked to supplements specified in the user's supplement regimen or associated with the user profile more generally. Similarly, the application (or the user's smartphone or a remote database) can store a blacklist of tag identifiers readable by the wearable device but not associated with the system, such as NFC tags applied or integrated into other devices or products external to the system.

Thus, upon receipt of an inbound wireless identifier from the NFC reader in the mobile device, the wearable device can query this whitelist for a tag identifier that matches this inbound wireless identifier. If the whitelist returns a match between the inbound wireless identifier and a known tag identifier, the application can execute an intent cycle as described below.

Conversely, if the whitelist returns no match between the inbound wireless identifier and a stored tag identifier, the application can query a blacklist within the user profile (e.g., stored locally at the wearable device or connected mobile device) for tag identifiers that match the inbound wireless identifier. If the blacklist returns a match between the inbound wireless identifier and a stored tag identifier, the application can discard and ignore the inbound wireless identifier.

Conversely, if the whitelist and the blacklist both return no match between the inbound wireless identifier and a stored tag identifier, the application can query a database of registered tags (e.g., a remote database containing a list of tag identifiers associated with the system) for a tag identifier that matches the inbound wireless identifier. If the database returns a match for a tag identifier and confirmation that this tag identifier was not previously linked to another user account, the application can confirm authenticity of the inbound wireless identifier and execute a supplement linking cycle described below.

Conversely, if the database returns a match for a tag identifier and confirmation that this tag identifier was previously linked to another user account, the application can execute an unaffiliated supplement cycle described below.

Furthermore, if the database returns no match between the inbound wireless identifier and a stored tag identifier, the application can write the inbound wireless identifier to the blacklist. Later, upon again receiving this inbound wireless identifier, the wearable device can automatically discard and ignore this inbound wireless identifier.

### 5. Multiple Inbound Wireless Identifiers

In one variation, if the application receives multiple inbound wireless identifiers responsive to an interrogation signal broadcast by the wearable device, the application can: characterize proximity of tags that broadcast these wireless identifiers based on their wireless signal strengths (which may function as a proxy for proximity to the wearable device); select a particular inbound wireless identifier corresponding to greatest signal strength and therefore most likely broadcast by a tag arranged on a supplement package currently in or nearest the user's hand; and then execute the foregoing process based solely on this particular inbound wireless identifier. Additionally or alternatively, if the application reads a set of inbound wireless identifiers responsive to a sequence of interrogation signals as the wearable device is moving, the application can select a particular inbound wireless identifier corresponding characterized by uniform signal strength over this sequence of interrogation signals, which may indicate a spatial link between the wearable device and a corresponding supplement package (i.e., that the user is grasping the supplement package with the same hand wearing the wearable device).

In another implementation, if the application receives multiple inbound wireless identifiers responsive to an interrogation signal broadcast by the wearable device, the application can: characterize distances from the wearable device to tags that broadcast these wireless identifiers based on their signal strengths; isolate a subset of inbound wireless identifiers that fall within a threshold distance (e.g., 12 inches) and that were therefore most likely broadcast by tags arranged on supplement packages within or near the user's grasp; and then execute the foregoing process for each inbound wireless identifier in this subset.

### 6. Tag Interrogation Triggers

Generally, the application can repeat the foregoing process over time, such as once per five-second interval: while the application is open on the wearable device; while the wearable device detects motion; and/or while the wearable device falls within a threshold distance (e.g., 50 meters, 500 meters) of a geospatial location associated with past supplement consumption by the user (e.g., the user's home, a gym, an office).

In another example, the application repeats the foregoing process over time, such as once per five-second interval for up to two minutes after the application detects a “reach” gesture or a specific gesture trained for the system (e.g., a “grasp and shake a bottle” gesture) based on motion of the wearable device. In particular, in this example, the application can store a local copy of a motion model that predicts a hand—wearing a wearable device—reaching toward, grasping, and/or then shaking an object (e.g., a supplement package) based on motion (e.g., timeseries accelerations and angular velocities) of the wearable device. Accordingly, during operation, the application can: access timeseries motion data from motion sensors (e.g., an IMU) within the wearable device; and pass these timeseries motion data into the motion model. If the motion model returns a prediction that a hand wearing the wearable device is reaching, grasping, and/or shaking, the application can trigger the NFC reader to broadcast an interrogation signal and record inbound wireless identifiers, such as at a frequency of once per ten-second interval: for up to two minutes; until the wearable device receives at least one authentic wireless identifier; and/or until motion at the wearable device ceases. The application can then execute the foregoing methods and techniques to handle any inbound wireless identifier.

### 7. Supplement Linking Cycle

As described above, in response to authenticating an inbound wireless identifier as a tag identifier of a tag within the system and confirming that this tag identifier was not previously linked to another user account, the application can execute a supplement linking cycle. During this supplement linking cycle, the application can: prompt the user to place the tag on a supplement package (e.g., a bottle containing lozenges); prompt the user to identify the supplement type contained in this supplement package; and link the tag identifier to this supplement type and/or to this supplement package more specifically within the user profile.

For example, the application can: prompt the user to capture an image of the supplement package (e.g., a QR code on the supplement package); extract features from the image; and identify the supplement type and/or a format of the supplement package (e.g., a bottle of lozenges, a dropper bottle). In another example, the application can: retrieve a list of supplement types recently shipped to the user; and prompt the user to identify the supplement type or supplement package from this list. The application can then: retrieve supplement characteristics for the supplement type and/or supplement package (e.g., container size and type, batch number, supplement ship or open date, supplement format); and store a link—between the tag identifier and the particular supplement type (and related supplement characteristics—in the database and/or in the user profile.

Additionally or alternatively, the application can retrieve a motion model that predicts consumption events from the supplement package based on motion (e.g., linear accelerations, angular velocities) of the wearable device. For example, the database can store a population of motion models specific to supplement and supplement package formats, such as permutations of: large and small bottles, tubes, and droppers; containing supplements in lozenge, powder, and liquid formats. The application can then store a link—between the tag identifier and the motion model of the corresponding supplement package—in the user profile.

Later, during an intent cycle in which the application predicts the user's intent to consume a dose of this supplement, the application can pass motion of the wearable device—while the corresponding tag is nearby—into the motion model to predict a consumption event of this supplement from this supplement package.

### 8. Intent Cycle

Generally, during an intent cycle following receipt of an inbound wireless identifier matched to a tag identity linked to a supplement in the user profile, the application can verify consumption of the supplement at the current time, such as: if consumption of the corresponding supplement is scheduled within a current time window; if a minimum time since a last dose of the supplement consumed by the user has passed; and/or if consumption of a last dose of a conflicting supplement was previously detected by the wearable device (or manually confirmed by the user) outside of a minimum prescribed time between consumption of these supplements.

Upon verifying consumption of the supplement at the current time, the application can trigger the wearable device to output haptic (and/or visual) feedback (i.e., by actuating a vibrator, flashing a light element, rendering a prompt on a display) to indicate to the user that the application can verify consumption of the supplement at the current time (hereinafter a “haptic intent approval cycle”). The application can then: sample motion data from the wearable device; interpret a dosing event with the supplement based on motion of the wearable device (e.g., by matching motion of the wearable device to motion representative of a dose event from a supplement package associated with the supplement); generate a consumption record containing a time, a GPS location, and/or an identifier of this supplement; and writing this consumption record to the user's supplement history.

In particular, the application can verify a consumption window for the supplement type linked to the inbound wireless identifier. If this consumption window is open, the application can output haptic (and/or visual) feedback via the wearable device to indicate to the user that the application can verify consumption of the supplement at the current time, such as a by outputting a soft, long rumbling vibration over a period of five seconds. The application can also render a notification that the consumption window for this supplement is open, such as in the form of a brief description of the supplement and/or an image of the supplement paired with a green checkmark on a display of the wearable device (or activating a set of green light elements on the wearable device to indicate a recommended quantity of supplement to consume). Then, upon detecting a gesture representative of a consumption event while this tag remains within wireless range of the NFC reader in the wearable device, the application can: execute a haptic consumption cycle to indicate that consumption of the supplement type was detected; and generate and store a consumption record containing a time, a GPS location, and or an identifier of the supplement for this consumption event.

However, if the consumption window for this supplement is not open, the application can trigger the wearable device to output haptic (and/or visual) feedback to indicate to the user that consumption of the supplement at the current time is not recommended (hereinafter a “haptic consumption avoidance cycle”), such as by outputting high-amplitude, rapid pulses over a period of ten seconds or until the application matches motion of the wearable device to release of the supplement (e.g., a “release gesture”) or if the wearable device loses connectivity to the corresponding tag. The application can also render a notification that the consumption window is currently closed for this supplement, such as in the form of a brief description of the supplement type and a red “X.” Additionally or alternatively, the application can output an audible alarm to prompt the user to avoid consumption of the supplement at the current time.

### 8.1 Consumption Checks and Consumption Window

In one implementation, the application retrieves a consumption window for the supplement from the user's supplement regimen stored in the user profile. More specifically, the computer system can retrieve a consumption window—defining times of day in which the user is scheduled to consume the supplement—from the supplement regimen. Then, in response to a current time falling within the consumption window, the application can trigger the wearable device to vibrate according to a first vibration pattern during a haptic intent approval cycle to confirm consumption of the supplement at the current time and while the wearable device is proximal the supplement. Conversely, in response to the current time falling outside of the consumption window, the application can trigger the wearable device to vibrate according to a second vibration pattern—different from the first vibration pattern—during a haptic consumption avoidance cycle in order to prompt the user to delay consumption of this supplement.

In another implementation, the application verifies that: a minimum time since a last detected (or manually-confirmed) dose of the supplement consumed by the user has passed; the current time falls within a prescribed or selected consumption time window scheduled for this supplement; consumption of a dose of the supplement is unlikely to negatively interact with a dose of another supplement previously consumed by the user; and/or consumption of a dose of the supplement is unlikely to negatively interact with a dose of another supplement scheduled for consumption by the user at a later time. For example, the application can extract or retrieve a time of a last dose consumed by the user—for each supplement in the user's supplement regimen—from a supplement record stored in the user profile. Then, for the supplement associated with the inbound wireless identifier, the application can: query the supplement regimen for a minimum time between doses of the supplement; and query an interactions database for minimum durations between consumption of the supplement and earlier consumption of each other supplement (or active ingredient contained therein) in the supplement regimen to avoid negative supplement interactions. In response to confirming that the minimum time between doses of the supplement and minimum durations between doses of the supplement and each other supplement in the supplement regimen have passed, the application can execute a haptic intent approval cycle to haptically affirm the user's intent to consume a dose of the supplement. Otherwise, the application can execute a haptic consumption avoidance cycle to prompt the user to delay or avoid consumption of the supplement at the current time, as shown in FIG. 2.

### 9. Unaffiliated Supplement Cycle

Generally, the application can execute an unaffiliated supplement cycle following receipt of an inbound wireless identifier when the user reaches for a supplement linked to a profile of another user, such as a partner, a friend, a coach, a trainer, or a work associate. For example, the user may reach for a supplement not linked to her profile: in order to view details of a supplement suggested by this other user, such as while the user is at her office with this other user (e.g., a coworker); in order to consume a dose of a supplement suggested by the other user, such as while the user is at her gym with this other user (e.g., the user's trainer); or in order to consume a dose of a supplement—provided by this other user—that the user perceives as identical or similar to a supplement that the user forget to consumer earlier that day, such as while the user is at a friend's home, office, or gym.

As described above, the application can trigger the NFC reader in the wearable device to broadcast an interrogation signal and to record inbound wireless identifiers, such as at a rate of once per five second interval and/or in response to detection of a “reaching” gesture at the wearable device. Then, in response to matching an inbound wireless identifier to a valid tag identifier associated with another, second user profile, the application can execute an unaffiliated supplement cycle to selectively guide the user to: consume a dose of the product type; avoid consumption of the product type; and/or add the product type to the user's supplement regimen. In particular, during the unaffiliated supplement cycle, the application can: retrieve a supplement type linked to the inbound wireless identifier in the second user profile; retrieve characteristics of this supplement type (e.g., brand, product identifier or “SKU,” product description, dose or pill size, ingredient list or composition); and query the user profile for the same supplement type (e.g., the same product identifier).

### 9.1 Same Supplement Present in User Profile

Then, if the application identifies a supplement identical to the product type in the user's supplement regimen or user profile, the application can predict the user's intent to consume a dose of this product type—from a supplement container not currently associated with the user profile—and execute an intent cycle as described above.

In particular, the application can retrieve a consumption window for this supplement. If this consumption window is open for this supplement type, the application can: execute a haptic intent approval cycle (e.g., soft, long rumble) to confirm consumption of the product type by the user; and render a notification that the consumption window for this supplement type is currently open. Then, upon detecting a gesture representative of a consumption event while this tag remains within wireless range of the NFC reader in the wearable device, the application can: execute a haptic consumption cycle to indicate that consumption of the product type was detected; and generate and store a consumption record for this consumption event.

However, if the consumption window for this supplement type is not currently open, the application can: execute a haptic consumption avoidance cycle (e.g., high-amplitude, rapid pulsing) to prompt the user to avoid consumption of the product type; render a notification that the consumption window for this supplement type is currently closed; render a future time at which the consumption window for this supplement is predicted or scheduled to open; and/or output an audible alarm to prompt the user to avoid consumption of the product type.

### 9.2 Similar Supplement Present in User Profile

However, if the application fails to identify a supplement that matches the product type in the user's supplement regimen or user profile, the application can: retrieve a list of active ingredients of the product type associated with the inbound wireless identifier; and compare these active ingredients to active ingredients of other supplements currently specified in the user profile. In response to identifying a particular supplement in the user's profile that contains the same or similar active ingredients in the same or similar proportions as this product type, the application can: predict the user's intent to consume a dose of this product type in place of the particular supplement; retrieve a consumption window for the particular supplement; and execute an intent cycle for the product type as described above if the current time falls within this consumption window of the particular supplement.

Furthermore, the application can present details of the product to the user, such as: a manufacturer's description; a photograph; a list of active ingredients; a cost per dose; a recommended dose frequency (e.g., based on the user's age, gender, health goals); and/or a relevance score for the user (e.g., representing similarity between the user's health goals stored in the user profile and predict effects of the product type if consumed by the user). The application can then prompt the user to either: return to routine consumption of the particular supplement; replace the similar supplement with the product type currently (or recently) detected within wireless range of the wearable device; or serve a recommendation for a different supplement with different ingredients more capable of addressing the user's needs and avoiding overlap of mechanisms of action with other supplements currently linked to the user's account. If the user elects the latter, the application can automatically generate and place an order for the product type (e.g., for delivery to an address stored in the user profile). Once the user receives a unit of the product type, the user may apply a tag to this unit of the product type. The application can then: cooperate with the user to link this tag—and therefore the unit of the product type—to the user account; and remove the particular supplement—now replaced with the product type—from the user's regimen.

9.3 Identical and Similar Supplement Absent from User Profile

However, if the application fails to identify a supplement matching or similar to the product type in the user profile, the application can: retrieve a list of active ingredients of this product type; predict effects of the product type if consumed by the user; and characterize a relevance of the product type for the user based on (e.g., proportional to) a similarity between these predicted effects of the product type and health goals stored in the user profile.

Additionally or alternatively, the application can: query a drug interaction database for possible interactions between ingredients of the product type and ingredients of other supplements recently consumed by the user; and predict whether a dose of the product type at the current time will positively interact with, negatively interact with, or not interact with another supplement recently consumed by the user. Then, if the application predicts no interaction or only positive interaction between the product type and other supplements recently consumed by the user, the application can execute a haptic intent approval cycle—such as by triggering the wearable device to vibrate with a soft, long rumble—to indicate that the application has verified consumption of the product type. The application (or a second device, such as the user's smartphone) can also render a notification that consumption of the product type is approved and/or present details of the product to the user, such as: a manufacturer description; a photograph; a list of active ingredients; a cost per dose; a recommended dose frequency (e.g., based on the user's age, gender, health goals); and/or a relevance score for the user (e.g., representing similarity between the user's health goals stored in the user profile and predict effects of the product type if consumed by the user) on a display of the wearable device.

Then, upon detecting a gesture representative of a consumption event while this tag remains within wireless range of the NFC reader in the wearable device, the application can: execute a haptic consumption cycle to indicate that consumption of the product type was detected; and generate and store a consumption record for this consumption event. The application can also prompt the user to add the product type—currently (or recently) detected within wireless range of the wearable device—to the user's supplement regimen. If the user confirms addition of this product type to the supplement regimen, the application can automatically generate and place an order for the product type (e.g., for delivery to an address stored in the user profile). Once the user receives a unit of the product type and applies a tag to the product type, the application can cooperate with the user as described above to link this tag to the product type and to her user account.

Conversely, if the application predicts negative interaction between the product type and another supplement recently consumed by the user or specified in the user's supplement regimen, the application can execute a haptic consumption avoidance cycle to prompt the user to avoid consumption of the product type, such as including: triggering the wearable device to vibrate with high-amplitude, rapid pulses; rendering a notification that negative interactions are expected if the user consumes the product type, such as in the form of a brief description of the expected interaction and a red “X”; rendering a future time at which no negative interactions are predicted from consumption of this product type; and/or outputting an audible alarm to prompt the user to avoid consumption of the product type.

### 9.4 Supplement Shopping

The application and the wearable device can cooperate to execute similar methods and techniques in an unaffiliated supplement cycle while the user shops for, reaches for, and/or grasps supplements in a supplement store, at a grocery store, at a gym, etc.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for detecting and affirming intent to consume a supplement comprising:
at a wearable device worn on a hand of a user, broadcasting a wireless interrogation signal
receiving an inbound wireless identifier responsive to the wireless interrogation signal
in response to the inbound wireless identifier matching a tag identifier linked to a supplement in a user profile associated with the user:
detecting proximity of the supplement to the user
predicting intent of the user to consume a dose of the supplement
retrieving a consumption window for the supplement from a supplement regimen in the user account;
in response to a current time falling within the consumption window, vibrating the wearable device according to a first vibration pattern during a haptic intent approval cycle to confirm consumption of the supplement while the wearable device is proximal the supplement; and
in response to the current time falling outside of the consumption window, vibrating the wearable device according to a second vibration pattern during a haptic consumption avoidance cycle to prompt the user to delay consumption of the supplement.
